(19) United States
(12) Patent Application Publication
(10) Pub. No.: US 2014/0250027 A1
(43) Pub. Date: Sep. 4, 2014

(54) Tracking information display systems and related methods

(71) Applicant: United Parcel Service of America, Inc., Atlanta, GA (US)

(72) Inventors: Bala Ganesh, Alpharetta, GA (US); Scott Castaldo, Woodstock, GA (US); Amber Reed, Atlanta, GA (US)

(73) Assignee: United Parcel Service of America, Inc., Atlanta, GA (US)

(21) Appl. No.: 14/195,520

(22) Filed: Mar. 3, 2014

Related U.S. Application Data
(60) Provisional application No. 61/772,187, filed on Mar. 4, 2013.

(51) Int. Cl. G06Q 10/08

(52) U.S. Cl. CPC G06Q 10/0833
USPC 705/333

(57) ABSTRACT

A tracking information display system is described. The tracking information system detects a tracking number on a webpage and displays tracking information associated with the tracking number, regardless of which common carrier may be associated with the tracking number.

### CLAIM OF PRIORITY

This application claims the benefit of priority under 35 U.S.C. §119(e) to the filing date of U.S. Provisional Patent Application No. 61/772,187, filed Mar. 4, 2013, entitled, “Tracking Number Display Systems and Related Methods,” which is incorporated herein by reference in its entirety.

### BACKGROUND

When a consumer places an order (e.g., for one or more items) from an online retailer, the online retailer (e.g., as opposed to the consumer) often selects a logistics company to deliver the order. An online retailer may select different logistics companies to deliver different orders (e.g., or different items that make up the same order), even if the orders are placed by the same consumer at the same time. Logistics companies and/or retailers may also provide the consumer with a mechanism for checking the delivery status of an order. Thus, at any given time, the user may have to access multiple websites and/or tracking systems to check the delivery status of different orders (e.g., or different parts of the same order).

Various embodiments of the present systems and methods recognize and address the foregoing considerations.

### SUMMARY

A non-transitory computer-readable medium, in various embodiments stores computer-executable instructions for: 1) detecting a tracking number on a webpage; 2) at least partially in response to detecting the tracking number, displaying a user-selectable indicium on the webpage; 3) receiving notice that a user has selected the user-selectable indicium; 4) at least partially in response to the user selecting the user-selectable indicium, requesting tracking information associated with the tracking number; 4) receiving the requested tracking information; and 5) displaying the tracking information to the user. The tracking information, in a particular embodiment, is displayed without the user substantially leaving the webpage.

A computer system, in various embodiments, comprises at least one processor. In a particular embodiment, the computer system is configured for: 1) receiving, from a user, a request to display tracking information associated with one or more tracking numbers, the one or more tracking numbers displayed on a website and associated with one or more parcels; 2) obtaining the tracking information associated with the one or more tracking numbers; and 3) displaying the obtained tracking information to the user whilst the website displaying the one or more tracking numbers is substantially displayed to the user. According to various embodiments, the one or more tracking numbers are associated with a common carrier. In one or more embodiments, receiving the request to display the tracking information comprises receiving notice that the user has selected a user-selectable indicium associated with the one or more tracking numbers.

A computer system comprising at least one processor, according to various embodiments is configured for: 1) receiving notice that one or more tracking numbers are displayed on a webpage; 2) at least partially in response to receiving notice that the one or more tracking numbers are displayed on the webpage, obtaining tracking information associated with the one or more tracking numbers; and 3) displaying the tracking information associated with the one or more tracking numbers to the user.

### BRIEF DESCRIPTION OF THE DRAWINGS

Reference will now be made to the accompanying drawings, which are not necessarily drawn to scale, and wherein:

FIG. 1 is a block diagram of a Tracking Information Display System according to one embodiment;

FIG. 2 is a block diagram of an Exemplary Logistics Server of FIG. 1; and

FIG. 3 shows a flow diagram that generally illustrates various steps executed by the exemplary Webpage Analysis and Tracking Number Module in FIG. 2 in accordance with various embodiments of the system of FIG. 1.

### DETAILED DESCRIPTION OF VARIOUS EMBODIMENTS

Various embodiments will be described more fully hereinafter with reference to the accompanying drawings. It should be understood that the invention may be embodied in many different forms and should not be construed as limited to the embodiments set forth herein. Like numbers refer to like elements throughout.

### System Overview

A computer system, according to various embodiments, provides an enhanced tracking number interface. In various embodiments, the computer system is configured to: 1) detect a tracking number (which may be, for example, an alphanumeric string of characters) on a webpage, or within another document; 2) after detecting the tracking number, display a link (e.g., a selectable icon) adjacent the tracking number; 3) enable a user to select the link; and 4) in response to the user selecting the link, obtain the tracking information and display the tracking information to the user. In various embodiments, the system is configured to display tracking information for any of a plurality of different logistics companies or other companies. Accordingly, in particular embodiments, the system is adapted to allow the user to quickly access tracking information for parcels, regardless of the common carrier that is delivering the one or more parcels. In various embodiments, the system implements this functionality through an add-on to a browser, and displays the user-selectable indicium as a modification to an existing browser display.

In a particular example, User 1 has ordered one or more different items from an online retailer (e.g., Amazon®). To fulfill the order, the online retailer contracts with a different logistics company to deliver each of User 1's items. Each of the items may be shipped to User 1 in a separate parcel. Each logistics company assigns a different tracking number to each respective parcel to facilitate the delivery of the parcels to the customer. As part of its normal operations, the online retailer creates and maintains a list for User 1 on a webpage that shows each item purchased and each associated tracking number.

Continuing with this example, when the user accesses the webpage showing each tracking number, the system (which may include, for example, an add-on to the user's browser), scans the webpage and identifies each individual tracking number. The system may do this, for example, by scanning the webpage to identify any alphanumeric strings and/or symbols that correspond to the standard format of a particular logistic provider's tracking numbers. (For example, UPS' tracking numbers typically begin with the characters “1Z”). After the system has determined that one or more particular alphanumeric strings or symbols displayed on the webpage correspond to one or more tracking numbers, the system displays a link next to each respective tracking number on the webpage. User 1 may select any of these links to view the tracking information for the respective parcel containing (or that will contain) the respective item.

In various embodiments, in response to User 1 selecting one of the displayed links that corresponds to a particular parcel, the system obtains tracking information for the parcel. The system may do this, for example, by accessing the information from a database associated with a logistics provider that is handling the parcel. For example, the system may use an appropriate API to access the information from an appropriate computer system associated with the logistics provider. After obtaining the tracking information, the system displays the tracking information adjacent the link.

In various embodiments, the computer system is provided by a logistics company or any other suitable company that can access consumer data. Additionally, the system may be rendered on a user's computing device (e.g., desktop computer, mobile computing device, etc.), on a company's servers, on a social network server, on a third party server (e.g., a retailer's server), or on any combination of user's devices and servers.

### Exemplary Technical Platforms

As will be appreciated by one skilled in the relevant field, the present invention may be, for example, embodied as a computer system, a method, or a computer program product. Accordingly, various embodiments may be entirely hardware, entirely software, or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized, including, for example, hard disks, compact disks, DVDs, optical storage devices, and/or magnetic storage devices.

Various embodiments are described below with reference to block diagrams and flowchart illustrations of methods, apparatus (e.g., systems), and computer program products. It should be understood that each element of the block diagrams and flowchart illustrations, and combinations of elements in the block diagrams and flowchart illustrations, respectively, can be implemented by a computer executing computer program instructions. These computer program instructions may be loaded onto a general purpose computer, a special purpose computer, a smart mobile device, or another programmable data processing apparatus to produce a machine. As such, the instructions which execute on the general purpose computer, special purpose computer, smart mobile device, or other programmable data processing apparatus create means for implementing the functions specified in the flowchart block or blocks. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, block diagram elements and flowchart illustrations support combinations of mechanisms for performing the specified functions, combinations of steps for performing the specified functions, and program instructions for performing the specified functions. It should also be understood that each block diagram element and flowchart illustration, and combinations of block diagram elements and flowchart illustrations, can be implemented by special purpose hardware-based computer systems that perform the specified functions or steps, or combinations of special purpose hardware and other hardware executing appropriate computer instructions.

### Exemplary System Architecture

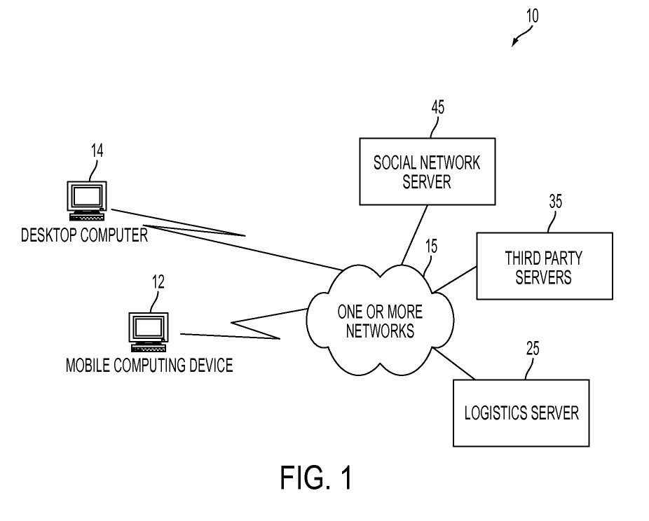

FIG. 1 shows a block diagram of a Tracking Information Display System 10 according to a particular embodiment of the present invention. As may be understood from this figure, the Tracking Information Display System 10 may include one or more Networks 15, a Logistics Server 25, one or more Third Party Servers 35 (e.g., a web hosting server, retailer's server, any other server that hosts websites), a Social Network Server 45 (e.g., a server associated with any service that allows users to make connections and/or to publically or privately share data, pictures, videos, or information), and one or more of the following: a Mobile Computing Device 12 (e.g., a handheld computing device, a laptop computer, a smart phone, a tablet computer, or any other mobile computing device) and/or a Desktop Computer 14.

The one or more Networks 15 facilitate communication between the Mobile Computing Device 12, Desktop Computer 14, Logistics Server 25, one or more Third Party Servers 35, and Social Network Server 45. These one or more Networks 15 may include any of a variety of types of computer networks such as the Internet, a private intranet, a public switch telephone network (PSTN), WAN, LAN, or any other type of suitable network. In certain variations of the embodiment shown in FIG. 1, both the communication link between the Mobile Computing Device 12, Desktop Computer 14, Logistics Server 25, one or more Third Party Servers 35, and Social Network Server 45 are implemented via the Internet using Internet Protocol (IP). The communication link between the Logistics Server 25, one or more Third Party Servers 35, and Social Network Server 45 may be, for example, implemented via a LAN or WAN.

It should be understood that the Servers 25, 35, and 45 do not necessarily need to be deployed over the network. For example, in various embodiments, any or all of Servers 25, 35, and 45 may be deployed locally and/or on the user's computer, tablet, and/or mobile device.

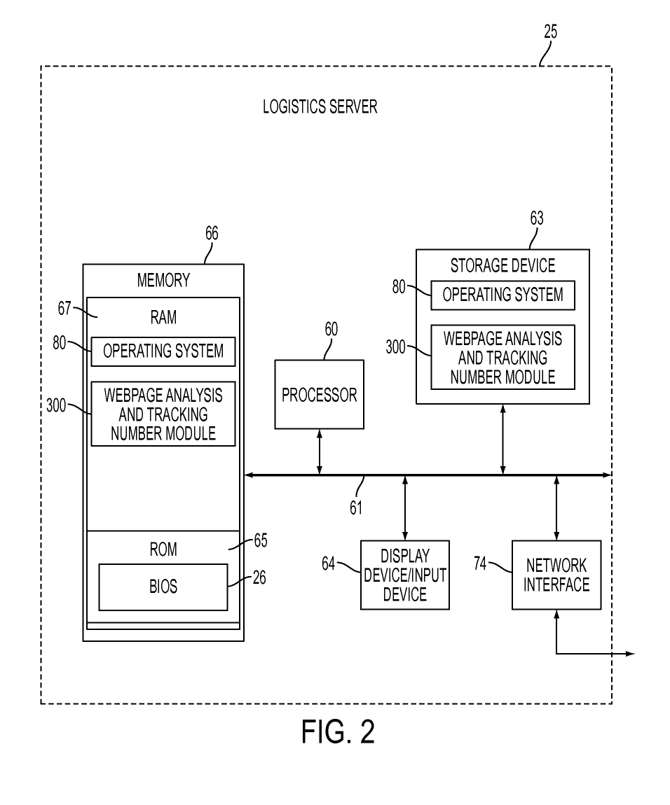

FIG. 2 shows a block diagram of an exemplary embodiment of an exemplary Logistics Server 25 that is configured for executing a Webpage Analysis and Tracking Number Module 300. It should be understood based on this disclosure that any suitable computers (e.g., any of the computing devices shown in FIG. 1) may be used to execute this module and that various steps executed by the module may be executed on different computers.

The Logistics Server 25 may include one or more basic computer hardware components. As may be understood from FIG. 2, in this embodiment, the Logistics Server 25 includes a Processor 60 that communicates with other elements within the Logistics Server 25 via a System Interface or Bus 61. The Logistics Server 25 also includes a Display Device/Input Device 64 for receiving and displaying data. This Display Device/Input Device 64 may be, for example, a keyboard, voice recognition, or pointing device that is used in combination with a monitor. The Logistics Server 25 further includes a Memory 66, which preferably includes both a Read Only Memory (ROM) 65 and a Random Access Memory (RAM) 67. The server's ROM 65 may be used to store a Basic Input/Output System (BIOS) 26 that contains the basic routines that help to transfer information between elements within the Logistics Server 25.

Also located within the Logistics Server 25 is a Network Interface 74 for interfacing and communicating with other elements of a computer network. It will be appreciated by one of ordinary skill in the art that one or more components of the Logistics Server 25 may be located geographically remote from other components of the Logistics Server 25 and/or that certain components may be omitted from particular embodiments. Furthermore, one or more of the components may be combined, and additional components performing functions described herein may be included in the Logistics Server 25.

The Logistics Server 25 may also include at least one Storage Device 63, such as a hard disk drive, a floppy disk drive, a CD-ROM drive, or an optical disk drive, for storing information on various computer-readable media, such as a hard disk, a removable magnetic disk, or a CD-ROM disk. As will be appreciated by one of ordinary skill in the art, each of these Storage Devices 63 may be connected to the Bus 61 by an appropriate interface. The Storage Devices 63 and their associated computer-readable media may provide nonvolatile storage for the Logistics Server 25. It should be noted that the computer-readable media described above could be replaced by any other type of computer-readable media known in the art. Such media includes, for example, magnetic cassettes, flash memory cards, and digital video disks.

A number of program modules may be stored by the various storage devices and/or within the RAM 67. Such program modules include an Operating System 80 and a Webpage Analysis and Tracking Number Module 300. For simplicity and brevity, these modules are merely exemplary and may represent a number of program modules which control certain aspects of the operation of the Logistics Server 25 with the assistance of the Processor 60 and the Operating System 80. Exemplary embodiments of the Webpage Analysis and Tracking Number Module 300 are described in more detail below.

### Webpage Analysis and Tracking Number Module

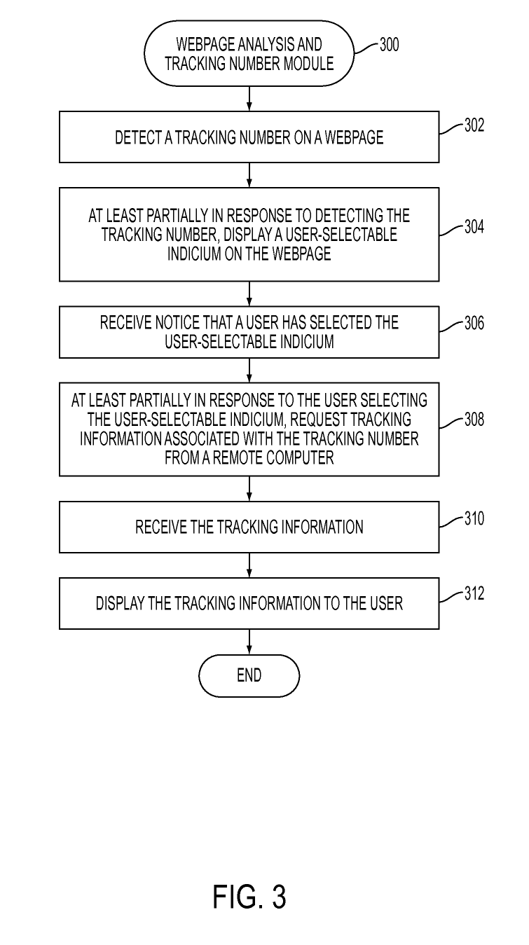

As shown in FIG. 3, certain embodiments of the Webpage Analysis and Tracking

Number Module 300 are configured to detect tracking numbers on webpages and display associated tracking information. The Webpage Analysis and Tracking Number Module 300 may operate alone or in combination with the Operating System 80 to perform that functions show in FIG. 3. It should be understood by one skilled in the art that certain embodiments of the Webpage Analysis and Tracking Number Module 300 may perform the functions shown in FIG. 3 in an order other than the order shown in FIG. 3. It should also be understood that various systems, when executing the Webpage Analysis and Tracking Number Module 300, may omit particular functions or executing additional functions in performing the functions of the Webpage Analysis and Tracking Number Module 300.

### Exemplary Embodiment of the Webpage Analysis and Tracking Number Module Shown In FIG. 3

Beginning at Step 302, the Webpage Analysis and Tracking Number Module 300 detects, on a webpage, one or more tracking numbers associated with one or more parcels. The system may be configured to detect the one or more tracking numbers on the webpage in any suitable way. In various embodiments, the system is configured to detect the tracking number by examining the webpage's data in order to find the tracking number in the underlying code (e.g., the system parses the webpage). In particular embodiments, the system is configured to detect the tracking number by searching the text of the webpage (e.g., the text the user sees) to find one or more patterns of numbers that may represent specific types of tracking numbers (e.g., UPS' tracking numbers typically begin with the characters “1Z”).

The system may be configured to detect the one or more tracking numbers in any format, even if, for example, the format is unique to a specific logistics company or carrier. In a particular embodiment, the one or more tracking numbers are in the format of a series of alphanumeric characters (e.g., 1ZDOAIHDF, LL812345098, 129HA32, HA12932323H, BHALIDOIH, 192341345148, etc.) In other embodiments, the one or more tracking numbers are in the form symbols, a series of one or more symbols, a digital certificate, and/or any other suitable format.

In various embodiments, the one or more tracking numbers may be associated with any common carrier. In particular embodiments, the one or more parcels are shipped by a national or international logistics company (e.g., UPS®). In a particular embodiment, the one or more parcels are shipped by one or more local and/or regional shipping companies.

The one or more parcels may be associated with one or more purchases from one or more online retailers (e.g., the user has ordered one or more items from the online retailer(s) and the one or more items are shipped in the one or more parcels). The one or more online retailers may be any online retailer(s). In various embodiments, the one or more online retailers is a retailer that sells one or more various brands, but specializes in a specific type of merchandise (e.g., an online shoe retailer). In other embodiments, the one or more online retailers specialize in one specific brand (e.g., Calvin Klein®). In still other embodiments, the one or more online retailers are general online retailers (e.g., Amazon®). In other embodiments, the one or more online retailers specialize in services, group discounts, and/or whole sale items.

Continuing to Step 304, the system, at least partially in response to detecting the tracking number, displays a user-selectable indicium on the webpage. The system may be configured to display the user-selectable indicium in any suitable form. In various embodiments, the system is configured to display the indicium by adding a highlight to the tracking number (e.g., by adding a transparent yellow box around the tracking number). In other embodiments, the system is configured to display the indicium as an underline of the tracking number (e.g., the system displays an underline under the tracking number and enables the user to select the tracking number and/or the underline). In further embodiments, the system is configured to display the indicium by changing the color of the text of the tracking number (e.g., the alphanumeric text of the tracking number is black as displayed on the webpage and the system is configured to change the tracking number so it appears to be blue or any other suitable color). In still further embodiments, the system is configured to display the user-selectable indicium as a symbol. The symbol may be a company logo, a registered trademark, and/or any other suitable symbol such as a heart, star, etc. According to various embodiments, the system is configured to display the user-selectable indicium as any combination of formatting (e.g., underline, text color, text highlight) and/or symbol.

The system may be configured, in various embodiments, to display the user-selectable indicium in one or more suitable locations adjacent to the tracking number (e.g., if the user-selectable indicium is a symbol). In some embodiments, the system is configured to display the user-selectable indicium to the right of the tracking number (e.g., the system displays the user-selectable indicium as a substantially heart-shaped object to the right of the tracking number on the webpage). In other embodiments, the system is configured to display the user-selectable indicium below, above, or to the left of the tracking number.

At Step 306, the system receives notice that a user has selected the user-selectable indicium. The system may be configured to enable the user to select the user-selectable indicium in any suitable way. In various embodiments, the system enables the user to select the indicium using a mouse or other pointer device. In one such embodiment, the system enables the user to select the indicium by directing a cursor controlled by a pointer device (e.g., a mouse) over the indicium, then selecting the indicium (e.g., by pressing a select button on the mouse). In other embodiments, the system is configured to enable the user to select the indicium by directing a pointer device (e.g., a mouse) over the indicium. In this embodiment, the user “rolls over” the indicium to select it.

In other embodiments, the system is configured to enable the user to select the indicium without the use of a pointer device. In one embodiment, the system enables the user to select the indicium by highlighting or moving a cursor over the indicium with a keyboard and pressing the select key on the keyboard (e.g., by pressing “enter” on the keyboard). In another embodiment, the system enables the user to select the indicium on a touch-screen. In this embodiment, the user places their finger or stylist (or other appropriate touch-screen interfacing mechanism) over the indicium and selects it by pressing on the touch-screen.

At least partially in response to the user selecting the user-selectable indicium, at Step 308, the system requests tracking information associated with the tracking number. The system may be configured to request the tracking information from any suitable source. In various embodiments, the system is configured to request the tracking information from a database which stores tracking information for particular users, which is accessed by an account associated with the user. In a particular example, the system may be configured to enable the user to login to an account through a website, a browser plug-in, and/or mobile application, and then the system is configured to request the tracking number for the user based on the account information associated with the user (e.g., a user name and password and/or other one or more unique credentials).

In further embodiments, the system is configured to request the tracking information from one or more remote computers associated with a common carrier via a browser add-on installed on a client device associated with the user. According to a particular embodiment, the browser add-on is configured to request the tracking number through an API associated with the one or more remote computers associated with a common carrier.

In various embodiments, the system is configured to request the tracking information from a third party associated with the tracking number and by transmitting the tracking number to the third party. In a particular example, the system submits the tracking number to one or more servers (e.g., the one or more Third Party Servers 35) associated with the third party and, at least partially in response to receiving the first tracking number, the third party transmits the first tracking information to the system.

According to various embodiments, the tracking information includes: 1) an expected delivery date for the one or more parcels associated with the tracking number; and 2) a delivery status for the one or more parcels associated with the tracking number. The expected delivery date, in various embodiments, is the future date the one or more parcels are scheduled to arrive at the user's shipping address. In other embodiments, the expected delivery date is the prior date the one or more parcels were scheduled to arrive at the user's shipping address (e.g., if the tracking number is associated with a shipment that was scheduled to arrive in the past). In further embodiments, the expected delivery date is the date the one or more parcels are scheduled to arrive at a place other than the user's shipping address (e.g., if the tracking number is associated with a parcel the user has shipped to someone else).

The delivery status is, in various embodiments, the current delivery status of the one or more parcels associated with the tracking number. For example, the delivery status may be “Delivered,” “In Transit,” or “Out For Delivery.” Additionally, the delivery status may provide further information. For example, in addition to “In Transit,” the delivery status may include further information pertaining to where the one or more parcels are currently located or the last check-point (e.g., within a logistics system) where the one or more parcels were scanned. In this example, in addition to “In Transit” the delivery status may also include information such as “Shipment received by carrier.”

It should be understood that, in various embodiments, the tracking information is not limited to the expected delivery date and the delivery status of the one or more parcels associated with the tracking number. The tracking information may also include, but is not limited to: the tracking number; information regarding the common carrier transporting the one or more parcels associated with the tracking number; the shipping service (e.g. “UPS® Ground”) used to deliver the one or more parcels associated the tracking number; an order number associated with a purchase of one or more items that are contained in the one or more parcels associated with the tracking number; the shipping date of the one or more parcels associated with the tracking number (e.g., the date the one or more parcels departed from an online retailer); the scheduled destination of the one or more parcels associated with the tracking number (e.g., Atlanta, Ga., U.S.A.); and/or the dates and times of events associated with the transportation of the one or more parcels associated with the tracking number (e.g., the details of the delivery status, such as “Feb. 21, 2013, 7:46:00 AM, Knoxville Tenn. U.S., Departure Scan”).

Returning to Step 310, the system receives the tracking information associated with the tracking number. In various embodiments, the system is configured to receive the tracking information from the same source where the system is configured to request the tracking information (e.g., at Step 308). In one such embodiment, the system is configured to receive the tracking information from the remote computer where the system was configured to request the tracking information (e.g., at Step 308). According to further embodiments, the system is configured to receive the tracking information from a source other than where the system is configured to request the tracking information. In a particular embodiment, the system is configured to receive the tracking information from a third-party source that receives the tracking information from the source where the system is configured to request the tracking information (e.g., the system is configured to request the tracking information from Source 1, but the system is configured to receive the tracking information from Source 2).

At Step 312, the system displays the tracking information to the user. The system may display the tracking information in one or more suitable locations. In various embodiments, the system displays the tracking information on the same webpage as the tracking number is displayed. In this embodiment, the system is configured to, for example, display the tracking information adjacent the tracking number on the webpage. In further embodiments, the system is configured to display the tracking information adjacent the user-selectable indicium displayed to the user when the system detects a tracking number on a webpage (e.g., at Step 304).

According to a particular embodiment, the system is configured to display the tracking information on a separate webpage. In further embodiments, the system is configured to display the tracking information in a browser add-on/plug-in window. In still further embodiments, system is configured to display the tracking information in a new webpage that is opened at least partially in response to the user selecting the user-selectable indicium.

The system may be configured to display the tracking information in any suitable arrangement. In a particular embodiment, the system is configured to display the tracking information for each tracking number adjacent to each respective tracking number. In a particular example, a webpage accessed by a user displays three tracking numbers. The system, as described above, detects the tracking numbers on the webpage and receives the tracking information for each tracking number (e.g., three separate sets of tracking information, one set for each of the three tracking numbers). Continuing with this example, the system is configured to display each set of tracking information for each respective tracking number separately and adjacent each respective tracking number (e.g., the tracking information for the first tracking number is displayed adjacent the first tracking number, the tracking information for the second tracking number is displayed adjacent the second tracking number, etc.).

In further embodiments, the system is configured to display the tracking information for each tracking number in a single list arranged in substantially the same way as the tracking numbers are arranged on the webpage (e.g., the tracking information for the tracking number at the top of the webpage is displayed at the top of the list of tracking numbers, the tracking information for the tracking number at the bottom of the webpage is shown at the bottom of the list of tracking numbers, etc.). In still further embodiments, the system is configured to display the tracking information for each tracking number in a single list arranged in a substantially different way than the tracking numbers are arranged on the webpage.

### Alternate Embodiments

Alternative embodiments of the system may comprise features that are, in some respects, similar to the various components described above. Selected distinguishing features of these alternative embodiments are discussed below.

The System May Require the User to Login to an Account

In various embodiments, the system is configured to require the user to login to an account associated with a logistics system. In a particular embodiment, the system is configured to require the user to login to an account associated with the logistics system to enable the system to access tracking information that is associated with the user's account. In further embodiments the system may be configured to enable the user to login to one or more accounts with one or more logistics systems (e.g., the user is enabled to login to accounts associated with multiple logistics providers) to enable the system to access the tracking information associated with each of the one or more logistics systems.

The System May Display Information in Addition to the Tracking Information

In various embodiments, the system is configured to display additional information when the system is configured display to the tracking information as described in Step 312. The system may, for example, display account information associated with the user that the system uses to obtain the tracking information associated with the tracking number. In a particular example, the system is configured to display a user name associated with the account associated with the user.

In further embodiments, the system is configured to display information related to the one or more items associated with the tracking information. In a particular embodiment, the system is configured to display links to receipts for the purchase of the one or more items, shipping labels to be used to the return the one or more items, and/or other appropriate links.

In various embodiments, the system is configured to display advertisements with the tracking information. In a particular embodiment, the advertisements are related to the one or more items associated with the tracking number (e.g., the advertisements are for items which may be accessories of the one or more items). In further embodiments, the advertisements are unrelated to the one or more items associated with the tracking number.

In various embodiments, the system may be configured to enable the user to modify shipping options displayed in the tracking information. In a particular embodiment, the system enables the user to change, for example, the delivery date of the one or more parcels at least partially in response to the tracking information being display as described in Step 312.

The System May Be Substantially Integrated Into a Mobile Computing Device

In various embodiments, the system is configured to be substantially integrated into a mobile device associated with the user. In a particular embodiment, the system is configured to detect a tracking number and display an indicium on a webpage that is optimized for a mobile computing device. In some embodiments, the system may be configured to operate on a touch screen and/or be integrated with voice and/or other commands by the user.

The System May Detect One or More Tracking Numbers on Any Type of Document

In various embodiments, the system is configured to detect the one or more tracking numbers displayed on any type of document/page (e.g., at Step 302). In a preferred embodiment, the system is configured to detect the one or more tracking numbers on a webpage accessed by the user (e.g., a document formatted in HTML). In further embodiments, the system is configured to detect the one or more tracking numbers displayed on a document formatted in portable document format (“PDF”). In still further embodiments, the system is configured to detect the one or more tracking numbers contained in an extendable markup language document (e.g., a document in “XML” format).

The User-Selectable Indicium May Be Displayed In Any Suitable Location

In various embodiments, the system is configured to display the user-selectable indicium in a location other than on the webpage as described in Step 304. In a particular embodiment, the system is configured to display the user-selectable indicium on a separate webpage. In further embodiments, the system is configured to display the indicium in a pop-up style window. In still further embodiments, the system is configured to display the indicium in one or more other suitable locations.

### Conclusion

Many modifications and other embodiments of the present systems and methods will come to mind to one skilled in the art having the benefit of the teachings presented in the foregoing descriptions and associated drawings. Therefore, it is to be understood that the present systems and methods are not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A non-transitory computer-readable medium storing computer-executable instructions for:
(A) detecting a tracking number on a webpage;
(B) at least partially in response to detecting the tracking number, displaying a user-selectable indicium on the webpage;
(C) receiving notice that a user has selected the user-selectable indicium;
(D) at least partially in response to the user selecting the user-selectable indicium, requesting tracking information associated with the tracking number;
(E) receiving the tracking information; and
(F) displaying the tracking information to the user,
wherein the tracking information is displayed without the user substantially leaving the webpage.

2. The non-transitory computer-readable medium of claim 1, wherein the computer-executable instructions are adapted for execution by a processor as an add-on to a web browser.

3. The non-transitory computer-readable medium of claim 2, wherein the tracking information is displayed by the web browser.

4. The non-transitory computer-readable medium of claim 1, wherein the tracking number is associated with one or more parcels containing one or more items purchased from an online retailer.

5. The non-transitory computer-readable medium of claim 4, wherein the tracking information comprises:
(A) a delivery status of the one or more parcels; and
(B) a shipment date of the one or more parcels.

6. The non-transitory computer-readable medium of claim 5, wherein requesting tracking information associated with the tracking number comprises sending the tracking number to a remote computer.

7. The non-transitory computer-readable medium of claim 6, wherein sending the tracking number to the remote computer comprises sending the tracking number to the remote computer via an application programming interface.

8. The non-transitory computer-readable medium of claim 7, wherein receiving the tracking information comprises receiving the tracking information via the application programming interface.

9. The non-transitory computer-readable medium of claim 8, wherein the application programming interface is associated with a logistics company.

10. The non-transitory computer-readable medium of claim 9, wherein the tracking information is displayed in a location selected from a group consisting of:
(A) on the webpage in a location that is substantially adjacent the user-selectable indicium; and
(B) in a browser window substantially separate from the webpage where the tracking number is displayed.

11. A computer system comprising:
at least one processor; wherein said computer system is configured for:
(A) receiving, from a user, a request to display tracking information associated with one or more tracking numbers, the one or more tracking numbers displayed on a website and associated with one or more parcels;
(B) at least partially in response to receiving the request, obtaining the tracking information associated with the one or more tracking numbers;
(C) displaying the obtained tracking information to the user whilst the website displaying the one or more tracking numbers is substantially displayed to the user; and
wherein:
the one or more tracking numbers are associated with one or more common carriers; and
receiving said request to display said tracking information comprises receiving notice that the user has selected a user-selectable indicium associated with the one or more tracking numbers.

12. The computer system of claim 11, wherein said one or more parcels are scheduled for delivery to the user by the one or more common carriers.

13. The computer system of claim 12, wherein the tracking information comprises:
(A) a delivery status of the one or more parcels;
(B) a shipment date of the one or more parcels; and
(C) information associated with the one or more common carriers.

14. The computer system of claim 13, wherein displaying the obtained tracking information to the user comprises displaying:
(A) the delivery status of the one or more parcels;
(B) the shipment date of the one or more parcels; and
(C) the information associated with the one or more common carriers.

15. The computer system of claim 14, wherein displaying the obtained tracking information to the user further comprises displaying the obtained tracking information adjacent the one or more tracking numbers.

16. The computer system of claim 15, wherein the delivery status of the one or more parcels comprises the current delivery status of the one or more parcels associated with the one or more tracking numbers.

17. The computer system of claim 16, wherein the current delivery status of the one or more parcels is a status selected from a group consisting of:
(A) Delivered;
(B) In Transit; and
(C) Out for Delivery.

18. A computer system comprising:
at least one processor, wherein said computer system is configured for:
(A) receiving notice that one or more tracking numbers are displayed on a webpage;
(B) at least partially in response to receiving notice that the one or more tracking numbers are displayed on the webpage, obtaining tracking information associated with the one or more tracking numbers; and
(C) displaying the tracking information associated with the one or more tracking numbers to the user.

19. The computer system of claim 18, wherein displaying the tracking information comprises displaying the tracking information adjacent the one or more tracking numbers.

20. The computer system of claim 18, wherein receiving notice that the tracking number is displayed on the webpage comprises the user indicating that the one or more tracking numbers are displayed on the webpage.

21. The computer system of claim 20, wherein the user indicating that the one or more tracking numbers are displayed on the webpage comprises the user selecting a user-selectable indicium, wherein the user-selectable indicium is displayed via a web browser.

22. The computer system of claim 20, wherein the computer system is further configured to, at least partially in response to the user indicating that the one or more tracking numbers are displayed on the webpage, scan the webpage for the one or more tracking numbers.

23. The computer system of claim 22, wherein the system is further configured to obtain the tracking information at least partially in response to scanning the webpage.

24. The computer system of claim 23, wherein obtaining tracking information associated with one or more tracking numbers comprises obtaining the tracking information via an application programming interface.
